(19) United States
(12) Patent Application Publication
(10) Pub. No.: US 2012/0288839 A1
(43) Pub. Date: Nov. 15, 2012

(54) SURGICAL SIMULATION MODEL AND METHODS OF PRACTICING SURGICAL PROCEDURES USING THE SAME

(76) Inventor: Traves Dean Crabtree, Glen Carbon, IL (US)

(21) Appl. No.: 13/557,436

(22) Filed: Jul. 25, 2012

(30) Foreign Application Priority Data
May 12, 2010 (EP) 10 162 623.2

(51) Int. Cl. G09B 23/30

(52) U.S. Cl. 434/267

(57) ABSTRACT

A surgical training simulation anatomical model for demonstrating, practicing, or evaluating a human lung surgical procedure is provided. The model includes a plurality of segments coupled together to form a skeletal frame representative of a portion of a human anatomy. The skeletal frame encloses at least a first component and a second component. The first component is representative of a patient's heart. A second component is representative of a patient's lung. The first component includes a plurality of hollow channels that extend at least partially through the second component for channeling pressurized fluid there through to simulate the behavior of a patient's heart and cardiopulmonary system during a surgical procedure of the patient's lung. The channels are oriented in a closed loop and include a plurality of nodes defined therein that are positioned to simulate lymph nodes in the patient.

### BACKGROUND OF THE INVENTION

The field of the invention relates generally to simulation systems, and, more particularly, to a surgical simulation apparatus that may be used to train healthcare professionals.

Facilities, such as medical schools and teaching hospitals, often use surgical simulation for training purposes. Surgical simulation enables medical and nursing students and healthcare professionals to practice and hone their skills before treating live human patients. More specifically, surgical simulation may include the use of computers and/or inanimate training devices, such as man-made training aids and/or cadavers that trainees can use to practice with. For example, at least some surgical simulation includes the use of computer-based systems that help establish precision placement for surgeries. Similarly, using inanimate training devices that mimic the human body may also be used for simulating a surgery.

Often animal models, such as canine, porcine, or bovine specimens, are used. While these animals do offer an in vivo environment, their anatomy differs significantly from that of a human. Moreover, such specimens are often very costly and may create biohazard waste issues. To get around such issues, often cadavers are used for surgical training Unfortunately, the usefulness of such models may be limited. For example, although cadaver tissues provide an accurate representation of anatomical geometry, the required chemical preservation greatly alters the physical properties of the tissues. Moreover, in such models biological flows cannot be simulated, and the number of models available may be limited. Furthermore, animal models do not include nor demonstrate the appropriate landmarks and proportions of humans. As such, animal models typically provide only limited benefits.

As a result, at least some developers have created static anatomic training models or benchtop fixtures. Although useful, generally such models are typically designed to demonstrate gross anatomy and are not for simulation and often lack surgical detail. Moreover, such models are usually fabricated from typical engineering materials such as metal, glass, and/or plastic. Moreover, at least some known devices are unable to replicate portions and features of a functioning human body system. For example, at least some known training devices are unable to replicate a functioning pulmonary system. More specifically, known training devices used to train surgeons on the pulmonary system do no include any fluids circulating through the device that simulate blood flow. Similarly, there are no known pulmonary system training devices that include fluids circulating therethrough that simulate real time arterial and veneous blood flow or lymph flow through the patient. Moreover, outside of animal models, static anatomic models do not include dynamic inflation/deflation of the lung tissue. As a result, the usefulness of such models may be limited.

### BRIEF DESCRIPTION OF THE INVENTION

In one embodiment, a surgical simulation model is provided. The surgical simulation model includes a skeletal frame and a first module that is representative of a first organ is coupled within the skeletal frame. The first module is formed with plurality of hollow channels that are configured to channel pressurized fluid therethrough to simulate the function of the patient's first organ during a surgical procedure. The surgical simulation model also includes at least one second module that is representative of a second organ coupled within the skeletal frame and within the first module. The second module is configured to receive fluid discharged from the first module to simulate the function of a patient's second organ during the surgical procedure.

In another embodiment, a surgical system is provided. The surgical system includes at least one pump and a surgical simulation model coupled to the pump to enable the pump to channel fluid to the model. The model includes a skeletal frame and a first module that is representative of a patient's first organ coupled within the skeletal frame. The first module includes a plurality of hollow channels defined therein that enable pressurized fluid to be channeled throughout the first module to simulate the behavior of the patient's first organ during a surgical procedure to the patient. At least one second module, representative of a second organ of the patient is coupled within the skeletal frame. The second module is coupled in flow communication to the first module and receives pressurized fluid discharged from the first module to simulate the behavior of the second organ during the surgical procedure.

In yet another embodiment, an anatomical model for demonstrating, practicing, or evaluating a human lung surgical procedure is provided. The model includes a plurality of segments coupled together to form a skeletal frame representative of a portion of a human anatomy. The skeletal frame encloses at least a first component and a second component. The first component is representative of a patient's heart. A second component is representative of a patient's lung. The first component includes a plurality of hollow channels that extend at least partially through the second component for channeling pressurized fluid there through to simulate the behavior of a patient's heart and cardiopulmonary system during a surgical procedure of the patient's lung. The channels are oriented in a closed loop and include a plurality of nodes defined therein that are positioned to simulate lymph nodes in the patient.

In a further embodiment, a method of practicing a human lung surgical procedure is provided. The method includes providing an anatomical model representative of a portion of a human anatomy, wherein the model includes a plurality of segments coupled together to form a skeletal frame, and at least a first component that is representative of a patient's heart, and a second component that is representative of a patient's lung. The method also includes channeling pressurized fluid through a plurality of hollow channels that extend from the first component at least partially through the second component to simulate the behavior of a patient's heart and cardiopulmonary system during a surgical procedure of the patient's lung; and allowing a user to practice the surgical procedure using the anatomical model.

### BRIEF DESCRIPTION OF THE DRAWINGS

FIG. 1 is a block diagram of an exemplary surgical training system;

FIG. 2 is a front partial internal schematic view of a portion of an exemplary surgical simulation model that may be used with the system shown in FIG. 1;

FIG. 3 is a rear partial internal schematic view of a portion of the model shown in FIG. 2;

FIG. 4 is a an enlarged internal schematic view of a portion of the model shown in FIG. 2;

FIG. 5 is a partial cross-sectional schematic view of a portion of the model shown in FIG. 4

FIG. 6 is a cross-sectional schematic view of a portion of the model shown in FIG. 5 and taken from area 6; and

FIG. 7 is a cross-sectional schematic view of a portion of the model shown in FIG. 5 and taken from area 7.

### DETAILED DESCRIPTION OF THE INVENTION

The exemplary apparatus, systems, and methods described herein overcome at least some known disadvantages associated with at least some known surgical simulation models or devices by providing a surgical simulation model that can be used to perform a lung surgical procedure using a model that replicates portions and features of a functioning human anatomy. More specifically, in the exemplary embodiment, pressurized fluids may be circulated through channels defined in the model that are representative of, and simulate the behavior of, a portion of a circulatory system of a patient, including a portion of their cardio-respiratory system and their lymphatic system. Accordingly, the apparatus described herein provides and/or simulates an environment that is more realistic and more accurately depicted, and that more closely mirrors the behavior of a human anatomy during a surgical procedure than is available with known surgical training aids.

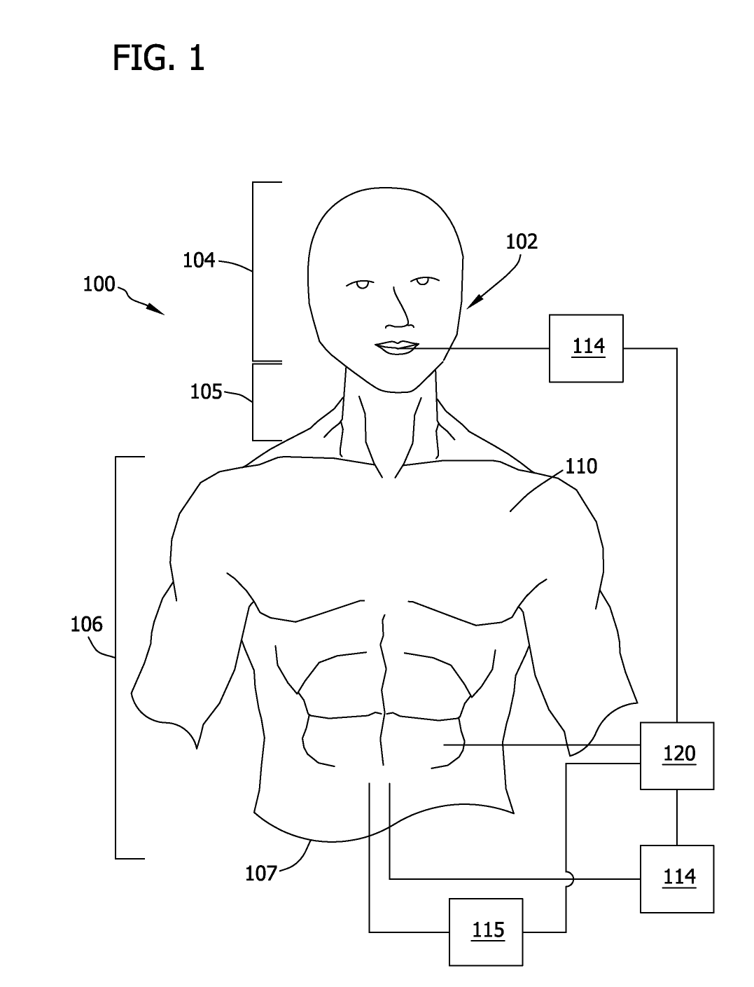

FIG. 1 illustrates a block diagram of an exemplary surgical simulation system 100. In the exemplary embodiment, system 100 is a dynamic simulation system of a human body that may undergo a surgical procedure. While the exemplary embodiment illustrates a simulation system representative of a human body, the present invention is not limited to only being representative of a human body, and one of ordinary skill in the art will appreciate that the current disclosure may be used in connection with other types of systems and animals that may undergo a surgical procedure, such as for example, other mammals. Moreover, although the present embodiment illustrates a lung surgical simulation system, one of ordinary skill in the art will appreciate that the present invention is not limited to only being used with lung surgical procedures and that other simulation system 100 can be tailored for use with surgical procedures on other portions of the anatomy.

In the exemplary embodiment, surgical simulation system 100 includes a surgical simulation model 102 that is representative of, and as described in more detail below, simulates the behavior of, a portion of a human anatomy. In addition, surgical model 102 is fabricated with proportions, details, anatomic relationships, and other landmarks, that are reflective and representative of the human anatomy. More specifically, in the exemplary embodiment, surgical simulation model 102 is representative of the upper torso portion of a human body and includes a head portion 104, a neck portion 105, and a chest portion 106. Although head portion 104, neck portion 105, and chest portion 106 are illustrated in FIG. 1, surgical simulation model 102 may in the alternative or in addition to, include other portions of the human body, such as a pelvic region and/or leg portions. In an alternative embodiment, model 102 does not include head portion 104 or neck portion 105, and rather model 102 only includes chest portion 106. In such an embodiment, chest portion 106 may be formed as a single unitary device. In another embodiment, chest portion 106 may be formed as a pair of mating units that are split generally axially in a direction extending from head portion 104 towards a lower edge 107 of model 102. In a further alternative embodiment, model 102 may be formed with only a portion of chest portion 106. In the exemplary embodiment, chest portion 106 is a single unitary device that encloses various internal components (not shown in FIG. 1) of model 102.

Model 102 not only geometrically mimics and replicates a human, but also includes an exterior layer 110 and at least one interior layer (not shown) that extends from and is opposite exterior layer 110. The interior layer and exterior layer 110 are each fabricated from a material that simulates the physical characteristics of human tissue. More specifically, in the exemplary embodiment, exterior layer 110 is fabricated from a material having a texture, density, and resilience that is representative of, and that simulates human skin tissue. More specifically, in the exemplary embodiment, exterior layer 110 is a single piece of material that may be fabricated from substances that can be subjected to uniaxial and planar tensile straining, such as polymers, including but not limited to reduced polynomial hyperelastic materials. Such materials enable model 106 to be cut or dissected. The interior layer(s) of model 102 may be fabricated from a composite material that simulates both the dermis and subcutaneous fat layers of the human skin, as well as specified muscle layers. In the exemplary embodiment, exterior layer 110 may be applied onto the interior layer(s) with an adhesive, such as a polymer adhesive or glue. Alternatively, exterior layer 110 may be applied onto the interior layer(s) via any manner known in the art that enables model 102 and/or system 100 to function as described herein.

In one embodiment, model 102 is at least partially fabricated with known engineering materials, and/or synthetic analog materials, that simulate one or more physical properties of living tissues. Typical engineering materials, may include many metals, ceramics, and plastics may be used depending on the required analog properties. However, in cases where soft tissues are being simulated, it may be advantageous to use nonstandard materials, such as hydrogels. Hydrogel materials may include, but are not limited to only including, polyvinyl alcohol, polyvinyl pyrrolidone, polyethylene oxide, polyhydroxyethyl methacrylate; polyethylene glycol, hyaluronic acid, gelatin, carrageen, alginates, chondroitan sulfate, dermatan sulfate and other proteoglycan materials and/or combinations thereof Such materials are generally physically more tissue-like by their nature of incorporating water, and by controlling such parameters as molecular structure, density, wall thickness, durometer.

In other embodiments, model 102 may be at least partially fabricated from tissue analog materials. The term “tissue analog material(s)” as used herein refers to a material or combination of materials designed to simulate one or more physical characteristics or properties of a relevant living tissue. Analog materials may include, but are not limited to only including, hydrogel, interpenetrating polymer networks, fibers, silicone rubber, natural rubber, other thermosetting elastomers, other thermoplastic elastomers, acrylic polymers, other plastics, ceramics, cements, wood, styrofoam, metals, actual human tissues, actual animal tissues, and any combination thereof.

In each embodiment, the materials used in fabricating model 102 are selected to simulate one or more physical characteristics of a living tissue. Such physical characteristics may include, but are not limited to only including, uni-axial or multi-axial tensile strength or modulus, uni-axial or multi-axial compressive strength or modulus, shear strength or modulus, coefficient of static or dynamic friction; surface tension; elasticity; wetability; water content; electrical resistance and conductivity; dielectric properties; optical absorption or transmission, thermal conductivity, porosity, moisture vapor transmission rate, chemical absorption or adsorption; or combinations thereof. Each tissue analog material is selected so that one or more physical characteristics of the tissue analog material will sufficiently match the corresponding physical characteristic(s) of the relevant tissue on which the tissue analog material is based.

In the exemplary embodiment, system 100 includes at least one pump 114 that is coupled to model 102. More specifically, in the exemplary embodiment, two pumps 114 may be removably coupled to model 102 to enable pressurized fluid, such as air, to be selectively channeled through various conduits and channels (not shown in FIG. 1) defined within model 102. In the exemplary embodiment, at least one additional pump 115 is also removably coupled to model 102 to enable pressurized fluid to be selectively channeled through other conduits and channels (not shown in FIG. 1) defined within model 102. In the exemplary embodiment, pumps 114 and 115 are external to model 102. Alternatively, system 100 may include pump(s) 114 and/or 115 that are housed within model 102. In the exemplary embodiment, pumps 114 may be any type of fluid-moving pump that enables system 100 to function as described herein. In one embodiment, model 102 is removably coupled to one pump 114 which may be coupled to a reservoir (not shown) that contains various types of different fluids.

System 100 may be configured to control the fluid flow within model 102 either manually or via a control system. For example, in the exemplary embodiment, system 100 includes a controller 120 that is coupled to pumps 114 and/or 115, the reservoir, and/or model 102. More specifically, controller 120 may be programmable to enable the fluid flow being channeled to model 102 to be changed based on various operational parameters of model 102. For example, controller 120 may be programmed to channel fluid to model 102 when model 102 undergoes a change in pressure, such as when, for example, a portion of model 102 is either intentionally cut, or is inadvertently cut, by a surgical tool during a training surgical procedure. In an alternative embodiment, system 100 does not include controller 120, but rather a pressurized source having a controlled discharge rate is coupled to system 100, such as for example, a pressurized capsule that discharges fluid at a substantially constant pressure flow rate.

In one embodiment, system 100 includes a plurality of sensors (not shown) positioned within model 102. In such an embodiment, at least one of the sensors is coupled in flow communication with pump 114 or 115, or the fluid reservoir to enable a pressure of the flow within model 102 to be monitored externally to model 102. Moreover, in such an embodiment, at least one of the sensors may be positioned to measure an amount of pressure induced to a portion of model 102, such as may be induced to a patient's ribcage by an instrument during a surgical procedure.

In the exemplary embodiment, controller 120 may be a real-time controller and may include any suitable processor-based or microprocessor-based system, such as a computer system, that includes microcontrollers, reduced instruction set circuits (RISC), application-specific integrated circuits (ASICs), logic circuits, and/or any other circuit or processor that is capable of executing the functions described herein. In one embodiment, controller 120 may be a microprocessor that includes read-only memory (ROM) and/or random access memory (RAM), such as, for example, a 32 bit microcomputer with 2 Mbit ROM and 64 Kbit RAM. As used herein, the term “real-time” refers to outcomes occurring in a substantially short period of time after a change in the inputs affect the outcome, with the time period being a design parameter that may be selected based on the importance of the outcome and/or the capability of the system processing the inputs to generate the outcome.

During a training surgical simulation, a surgical instrument, such as a scalpel, may be used to dissect or cut into various portions of model 102. More specifically, the scalpel may cut into chest portion 106 to expose various internal components of model 102 for further surgical procedures and/or examination. In one embodiment, portions of model 102 within chest portion 106 may be inflated prior to the training surgical procedure being initiated. At the same time, pumps 114 and/or 115 may channel pressurized fluid into model 102. For example, and as explained in more detail below, a first fluid may be channeled into model 102 to simulate the flow of blood within a circulatory system of a patient, and a second fluid may be channeled into model 102 to simulate the flow of lymph within a lymphatic system of the patient. More specifically, in the exemplary embodiment, fluid pressurized by pump 114 is circulated through a closed loop path as is at least partially indicated by flow arrows. Similarly, fluid channeled via pump 115 enters a closed loop as indicated by flow arrows.

In alternative embodiments, a pump, such as pump 114 or 115, is used to fill the lymphatic system with the second fluid, rather than simulating lymphatic flow within the patient. In yet another embodiment, the lymphatic system within model 100 is not hollow, but rather is fabricated from a material that has the density, texture, and resilience of a patient's lymph nodes. Accordingly, a user may perform a training surgical procedure within a system that mirrors and/or simulates a much more enhanced and precise environment of the human body that is possible with known surgical training models. Model 102 provides for real feedback that is helpful in enabling a user to practice surgical procedures.

In the exemplary embodiment, generally model 102 is intended for a single, one-time surgical training procedure. For example, after a surgical training procedure is simulated on model 102, chest portion 106, and/or the components coupled within chest portion 106, the components within system 100 are not intended to be reassembled to enable subsequent surgical training procedures to be accomplished with that model 102. However, if a first surgical training procedure is performed on a right lung (not shown in FIG. 1) within model 102, a subsequent surgical training procedure may be performed on a left lung (not shown in FIG. 1) within model 102.

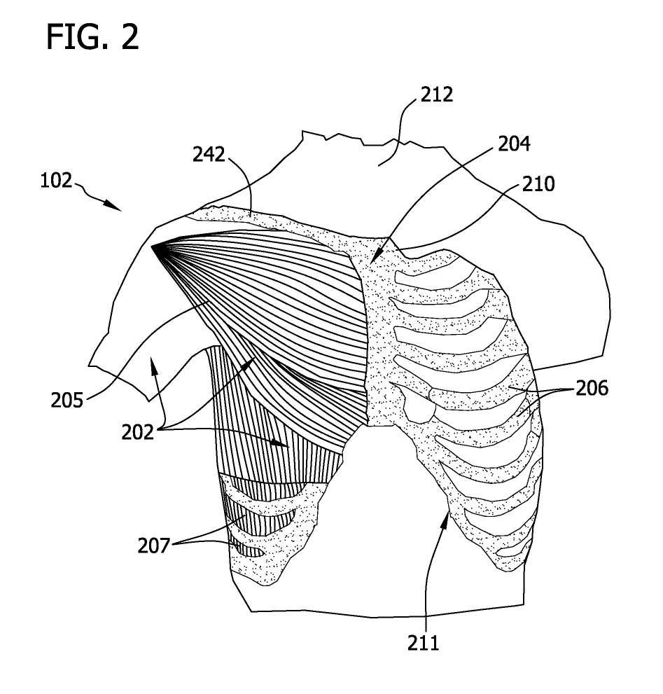

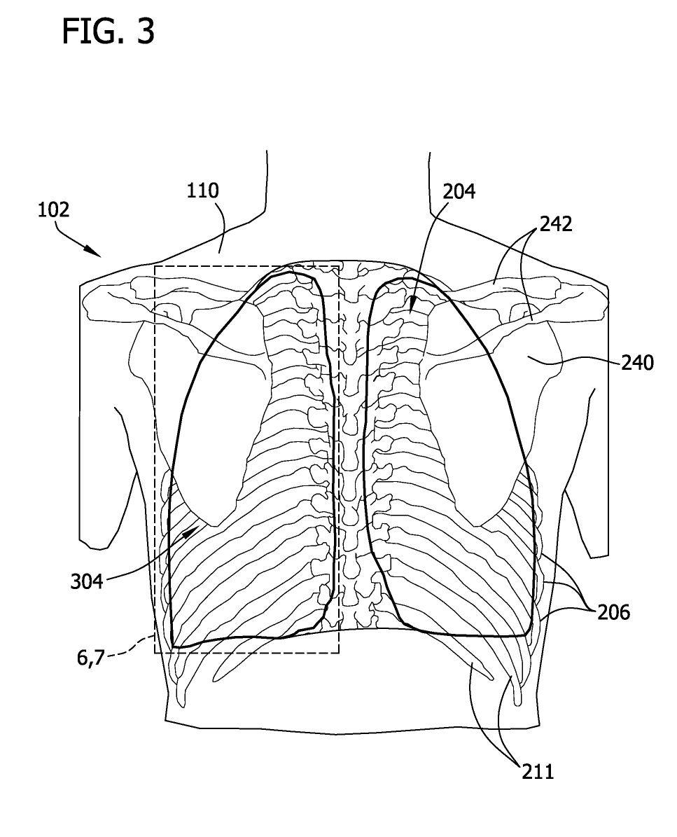

FIG. 2 is a front partial internal view of a portion of surgical simulation model 102. FIG. 3 is a rear partial internal view of a portion of model 102. More specifically, in the exemplary embodiment, in FIG. 2, a portion of external layer 110 has been removed to more clearly illustrate an internal view of chest portion 106. It should be noted, in FIG. 2, that a portion of muscle (described in more detail below) has also been removed from a left side (i.e., a heart side of an actual patient) to more clearly illustrate the internal portion of model 102. As best seen in FIG. 2, in the exemplary embodiment, model 102 includes a plurality of layers of material 202 that are each fabricated from a material that simulates the physical characteristics of muscle tissues found within a patient's chest. For example, layers 202 may be fabricated from fibrous material, such as polyacrylonitrile fibers, and/or types of polymers, such as thermoplastic polyurethane, and/or any other material or combination of materials that has the texture, density, and resilience that is representative of, and simulates a superficial fascia layer of muscle tissue. Moreover, in the exemplary embodiment, layers 202 may be representative of and simulate various muscle tissues of the human cervical and thorax regions. For example, layers 202 may be layered and oriented layered within model 102 so as to define the pectoralis muscle 205 and/or the intercostal muscle 207.

In the exemplary embodiment, model 102 also includes a plurality of cables (not shown) that are positioned within layers 202. The cables are fabricated from a material having a texture, density, and resilience that is representative of and that simulates various nerves located within the human body. For example, in the exemplary embodiment, the cables are fabricated from a polymer material, such as an elastomer material, and are oriented within layers 202 to represent various nerve locations, such as the intercostobrachial nerve.

Layers 202, in the exemplary embodiment, are also coupled to a skeletal frame 204. Skeletal frame 204, in the exemplary embodiment, includes a plurality of segments 206 that are fabricated from a material that is representative of a bone located within a chest portion of a human body. More specifically, in the exemplary embodiment, segments 206 are coupled together to form and simulate the human skeletal system. For example, as illustrated in FIGS. 2 and 3, segments 206 may be coupled together to define a rib cage 211. In the exemplary embodiment, segments 206 may be cut and severally removed from each other such that other components within model 102 may be examined

In the exemplary embodiment, model 102 also includes a plurality of first vessels or channels 210 and second vessels or channels 212 that extend through, and that are coupled within, layers 202. Vessels 210 and 212 may also be coupled to frame 204 at various segments 206. In the exemplary embodiment, first vessels 210 are representative of, and simulate, veins that form a human venous system, and second vessels 212 are representative of, and simulate, arteries of the human body. More specifically, in the exemplary embodiment, vessels 210 and 212 are hollow and each is coupled to pump 114 (shown in FIG. 1) to enable pump 114 to selectively channel pressurized fluid, such as liquid, through vessels 210 and 212 to simulate the circulation of blood through a portion of the human body.

Model 102, in the exemplary embodiment, also includes a pair of plates 240 coupled to frame 204 via a pair of segments 242. Plates 240 are oriented within model 102 and are each fabricated from a material that is representative of, and that simulates, the function and behavior of a scapula or shoulder blade within a human body. Segments 242 couple plates 240 within model 102 and are fabricated from a material that is representative of, and that simulates, the function and behavior of a clavicle within a human body. Alternatively, model 102 may not include plates 240 and/or segments 242.

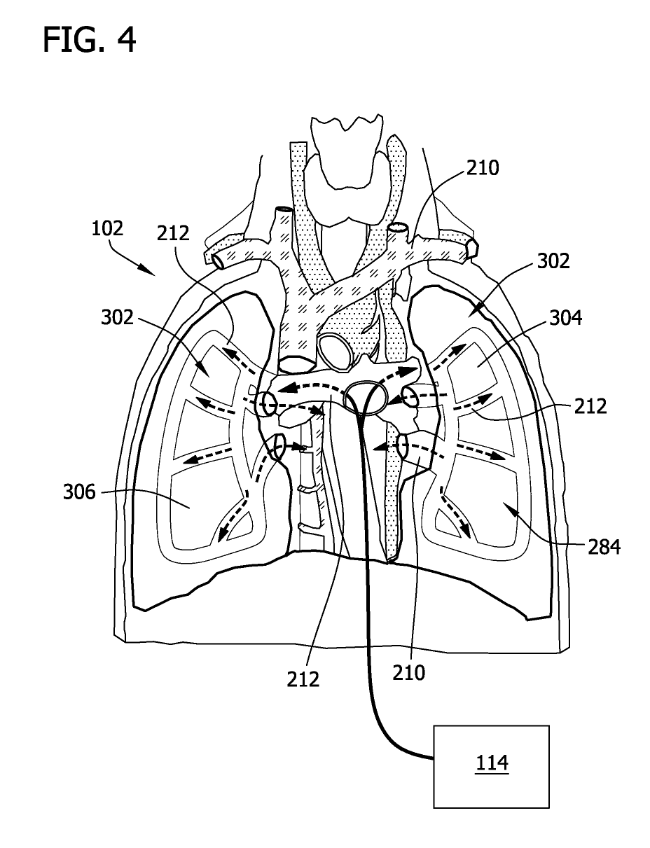

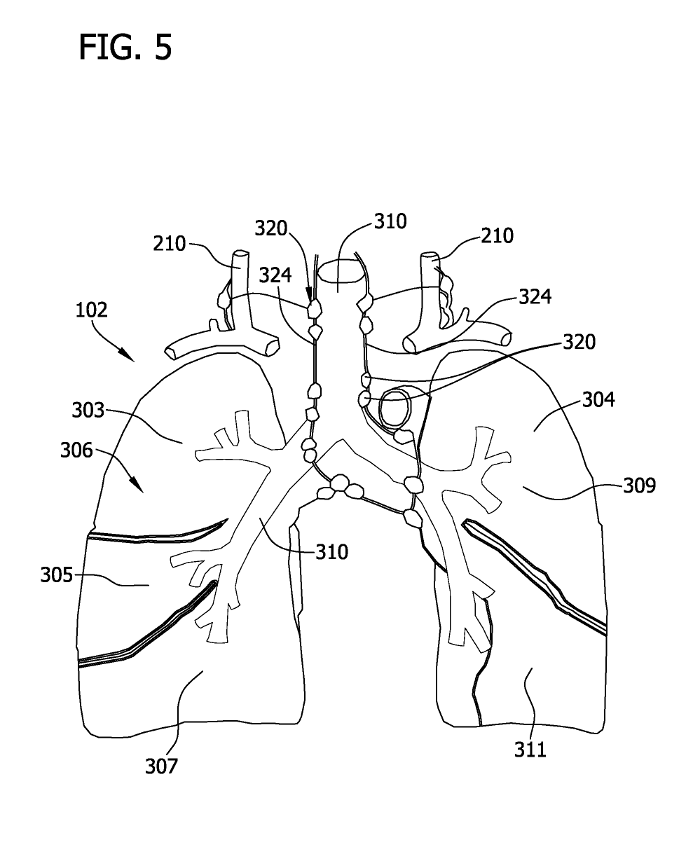

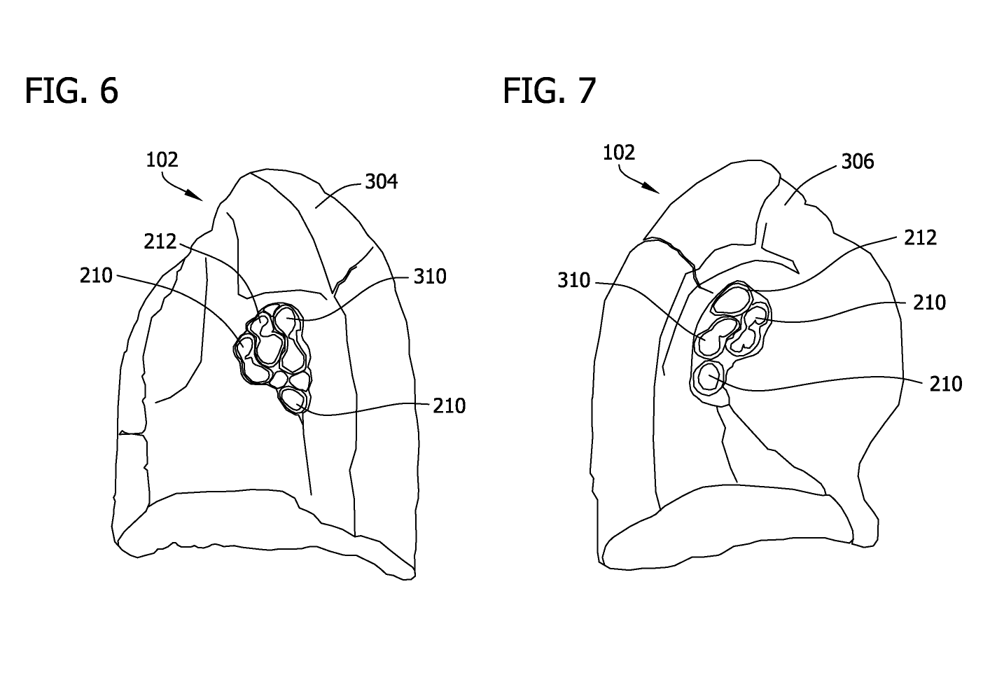

FIG. 4 is an enlarged internal view of a portion of model 102. FIG. 5 is a partial cross-sectional view of a portion of model 102. FIG. 6 is a cross-sectional view of a portion of model 102 taken from area 6, and FIG. 7 is a cross-sectional view of a portion of model 102 and taken from area 7. In the exemplary embodiment, model 102 is a surgical simulation model that is representative of the upper torso portion of a human body. More specifically, in the exemplary embodiment, model 102 is primarily intended for lung surgical training procedures, but is not limited to only being used with lung surgical training procedures. As such, in the exemplary embodiment, model 102 includes a first module 302 that is coupled to skeletal frame 204 and layers 202. More specifically, in the exemplary embodiment, portions of skeletal frame segments 206 define a rib cage 211, of a human body, that substantially circumscribes first module 302. Similarly, portions of layers 202 represent the pectoralis major muscle 205 (shown in FIG. 1) and extend across a front side 284 of first module 302. In the exemplary embodiment, model 100 also includes layers 282 that simulate the latissimus muscles and that simulate the serratus muscles of a human body.

In the exemplary embodiment, first module 302 is dynamic and is representative of and simulates the physical characteristics of lungs in a human body. More specifically, in the exemplary embodiment, first module 302 includes a first bladder-like portion 304 that is representative of and simulates the left lung, and a second bladder-like portion 306 that is coupled to first portion 304, and that is representative of and simulates the right lung. In the exemplary embodiment, portions 304 and 306 are fabricated from material that has a texture, density, and a resilience that is representative of, and simulates lung tissue within a human body. For example, in one embodiment, portions 304 and 306 may be fabricated from a polymer material, such as a flexible elastomer. Moreover, in the exemplary embodiment, each portion 304 and 306 includes a plurality of hollow channels 310 that representative of, and that simulate the bronchi and/or bronchioles of a human body.

More specifically, in the exemplary embodiment, portions 304 and 306 are fabricated to be representative of actual lung tissue found within a human body. As such, in the exemplary embodiment, portion 306 is internally segmented into three regions 303, 305, and 307 that simulate the respective superior, middle, and inferior lung lobes typically found in a right lung of a human body, and portion 304 is internally segmented into two regions 309 and 311 that simulate the respective upper and lower lung lobes typically found in the left lung of a human body.

Because portions 304 and 306 are hollow, portions 304 and 306 may be coupled to pump 114 (shown in FIG. 1) via channels 310 to enable a pressurized fluid or air, to be channeled through portions 304 and 306 to simulate air flow through a portion of a respiratory system of a human body. Vessels 210 and 212 are also routed through portions 304 and 306 such that additional pressurized fluids, such as liquids, may be channeled through portions 304 and 306 to simulate blood flow from a patient's heart through their lungs. More specifically, in the exemplary embodiment, vessels 210 and 212 are each routed to lung regions 203, 305, 307, 309, and 311 in a manner that simulates that portion of a circulatory system found in a human body.

Model 102 also includes at least one second module 320 that is coupled to first module 302 and is within skeletal frame 204. For example, second module 320 may be coupled to various portions of skeletal frame segments 206 and/or positioned within positioned within portions 304 and 306. In the exemplary embodiment, second module 320 is representative of and simulates a portion of a lymphatic system within a human body. More specifically, in the exemplary embodiment, model 102 includes a plurality of second modules 320 that are coupled together via a hollow conduit 324. In the exemplary embodiment, conduit 324 is representative of and simulates a lymphatic trunk including a plurality of lymph nodes. In the exemplary embodiment, conduit 324 and modules 320 are formed integrally together, but may be formed separately in other embodiments.

During a surgical training simulation using model 102, initially air may be channeled into channels 310 to inflate portions 304 and 306 and to simulate air flow through a portion of a respiratory system of a patient. Simultaneously, pressurized fluid may be channeled through vessels 210 and 212 simulate blood flow representative of the arterial flows to the patient's lung from the patient's heart, and the pulmonary venous flow from the lung back to the patient's heart. A sharp surgical tool, such as a scalpel, may be used to form an incision in model 102, and more specifically in model chest portion 106 (shown in FIGS. 1 and 3). In one embodiment, model 102 may be split as described above with respect to chest portion 106 to enable model 102 to be rotated approximately 90° to simulate the position of an actual patient undergoing such a surgical procedure.

The scalpel may then be used to cut through various layers 202 (shown in FIGS. 2 and 3). While cutting into layers 202, the scalpel may also cut into or through vessels 210 and 212 and/or through cables 203. When chest portion 106 and layers 202 have been severed, skeletal frame 204 may be visible and can also be dissected using a bone cutting tool. For example, segments 206 that define and simulate the sternum and the rib cage may be cut with a sternal saw such that an opening (not shown) may be defined that provides access to first module 302. Moreover, portions of chest portion 106 and/or skeletal frame 204 may be severally removed from model 102 such that first module 302 and/or second modules 320 are visible and can be physically examined A scalpel may then be used to remove a desired portion of first module 302 such that components within first module 302 may be visible for examination, as shown in FIG. 4.

Portions 304 and 306 of module 302 may then be surgically removed from locations where they are coupled to skeletal frame 204 prior to being physically removed from within model 102. A desired portion of each portion 304 and 306 may then be cut and removed with a surgical tool such that components within each portion 304 and 306 are visible for examination, as shown in FIGS. 5, 6, and 7. For example, channels 310 and/or portions of modules 320 and conduits 324 may be closely examined During this time, pumps 114 and 115 may continue to channel fluids through vessels 210 and 212, channels 310, modules 320, and/or conduits 324 to enable a visual and physical examination of the fluid flow therein.

Model 102 enables a user performing a surgical training simulation to accurately replicate the surgical procedures necessary to perform a lung surgical procedure on an actual patient. More specifically, model 102 enables a practicing surgeon to indentify each of the lung structures, i.e., the lung lobes, the arterial supplies, the venous drainage system, and the bronchi, for example, of an affected lobe, relative to, and while preserving the lung structures of the non-affected, i.e., non-diseased lobes or lung structures. As a result, to develop and hone their surgical skills, a surgeon using model 102 can dissect portions of model 102 without causing inadvertent injury or damage to other portions of model 102 in a realistic simulation. In an actual human, the arterial and venous structures within the lung are somewhat more delicate than vessels in other parts of the body, and are also generally difficult to access. Moreover, in an actual surgical procedure to a human, such inadvertent damage may be catastrophic.

As compared to known surgical simulation models or devices, the embodiments described herein provide a surgical training simulation apparatus that uses a simulation model that accurately replicates portions and features of a functioning human body system. The surgical simulation apparatus includes features that enable pressurized fluids to be circulated within portions of the model. Specifically, air may be channeled into portions of the model to simulate the behavior of the patient's circulatory system. Similarly, pressurized fluids may be channeled into the model to simulate flow into the lymphatic system of the patient and/or through a portion of the circulatory system of the patient. The surgical simulation apparatus described herein provides an accurate anatomic representation of a portion of a human, and because the apparatus is dynamic, the flows and fragility within that portion of the human are adequately simulated in a manner that provides an accurate replication and simulation of a lung surgical procedure. Accordingly, in the exemplary embodiment, the apparatus provides a lung surgical training model that more accurately depicts and functions similar to the behavior of an actual human patient in a more cost effective and realistic manner than is currently available through known surgical training models.

Exemplary embodiments of apparatus, systems, and methods are described above in detail. The apparatus, systems, and methods are not limited to the specific embodiments described herein, but rather, components of the systems, apparatus, and/or steps of the method may be utilized independently and separately from other components and/or steps described herein. For example, the apparatus may also be used in combination with other systems and methods, and is not limited to practice with only a lung surgical training system as is described herein. Rather, the exemplary embodiment can be implemented and utilized in connection with many other systems.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A surgical simulation apparatus comprising:
a skeletal frame representative of a skeletal structure within a body;
a first module representative of a first organ within the body, said first module coupled to said skeletal frame, said first module comprising a plurality of channels configured to channel fluid through said first module to simulate function of said first organ during use of said apparatus; and
at least one second module representative of a second organ with the body, said at least one second module coupled to said skeletal frame and to said first module such that said at least one second module is configured to receive fluid being discharged from said first module to simulate function of said second organ during operation of said apparatus, said skeletal frame.

2. An apparatus in accordance with claim 1, wherein said skeletal frame, said first module, and said at least one second module are substantially encased by at least one layer of material.

3. An apparatus in accordance with claim 2, wherein said housing is representative of skin tissue of the body.

4. An apparatus in accordance with claim 1, wherein said first module is representative of a respiration organ within the body, said first module comprises a first portion and a second portion coupled to said first portion, each of said first and second portions comprises said plurality of channels therein.

5. An apparatus in accordance with claim 4, wherein said plurality of channels are representative of at least one of arteries, veins, and bronchi in the body.

6. An apparatus in accordance with claim 1, wherein said at least one second module comprises a plurality of second modules representative of lymph nodes in the body.

7. An apparatus in accordance with claim 6, wherein at least a first of said plurality of second modules is coupled to at least a second of said plurality of second modules via a conduit representative of a lymphatic trunk in the body.

8. An apparatus in accordance with claim 1, wherein said first module and said at least one second module are each fabricated from an elastomer material.

9. A system comprising:
at least one pump; and
a surgical simulation apparatus coupled to said at least one pump such that said at least one pump is enabled to channel fluid to said apparatus, wherein said apparatus comprises:
a skeletal frame;
a first module representative of a first organ within the body, said first module coupled to said skeletal frame, said first module comprising a plurality of channels configured to channel fluid through said first module to simulate function of said first organ during use of said apparatus; and
at least one second module representative of a second organ with the body, said at least one second module coupled to said skeletal frame and to said first module such that said at least one second module is configured to receive fluid being discharged from said first module to simulate function of said second organ during operation of said apparatus, said skeletal frame.

10. A system in accordance with claim 9, wherein said apparatus further comprises at least one layer enclosing said skeletal frame, said first module, and said at least one second module therein.

11. A system in accordance with claim 10, wherein said at least one layer is representative of skin tissue on the body.

12. A system in accordance with claim 9, wherein said first module is representative of a respiration organ and comprises a first portion and a second portion coupled to said first portion, each of said first and second portions comprises said plurality of hollow channels therein.

13. A system in accordance with claim 12, wherein said plurality of channels are representative of at least one of arteries, veins, and bronchi in the body.

14. A system in accordance with claim 9, wherein said at least one second module comprises a plurality of second modules representative of lymph nodes in the body.

15. A system in accordance with claim 14, wherein at least a first of said plurality of second modules are coupled to at least a second of said plurality of second modules via a conduit representative of a lymphatic trunk in the body.

16. A system in accordance with claim 9, wherein said first module and said at least one second module are each fabricated from an elastomer material.

17. A method of assembling a surgical simulation apparatus, said method comprising:
coupling a plurality of segments together to form a skeletal frame that is representative of a portion of a rib cage found in a body;
coupling a first module representative of a first organ in the body to the skeletal frame, wherein the first module includes a plurality of hollow channels configured to channel fluid through the first module to simulate function of the first organ during operation of the apparatus; and
coupling at least one second module representative of a second organ in the body to the skeletal frame and to the first module, wherein the at least one second module is configured to receive fluid discharged from the first module to simulate function of the second organ during operation of the apparatus.

18. A method in accordance with claim 17, further comprising enclosing the skeletal frame, the first module, and the at least one second module within at least one layer of material that is representative of skin tissue in the body.

19. A method in accordance with claim 17, wherein coupling a first module further comprises coupling a first module that is representative of a respiration organ in the body to the first portion, wherein each of the first and second portions include the plurality of channels therein.

20. A method in accordance with claim 17, wherein coupling at least one second module further comprises coupling a plurality of second modules that are representative of lymph nodes in the body.
